(19) United States
(12) Patent Application Publication
(10) Pub. No.: US 2007/0260747 A1
(43) Pub. Date: Nov. 8, 2007

(54) Protecting Electronic File Transfer from Unauthorized Access or Copying

(76) Inventors: Jan Samzelius, San Francisco, CA (US); Tobias Karlsson, Haarlem (NL)

Correspondence Address: FISH & RICHARDSON P.C., PO BOX 1022, MINNEAPOLIS, MN, 55440-1022, US

(21) Appl. No.: 11/684,556

(22) Filed: Mar. 9, 2007

Related U.S. Application Data
(60) Provisional application No. 60/781,112, filed on Mar. 10, 2006.
(60) Provisional application No. 60/781,113, filed on Mar. 10, 2006.

(51) Int. Cl. H04L 9/00

(52) U.S. Cl. 709/238; 709/246; 726/26

(57) ABSTRACT

An electronic file is decomposed into a number of fragments. The fragments are assembled into a number of fragment files. Instructions for restoring the electronic file are generated. The fragment files are sent to a recipient device at different times and/or in a random (or different) order. In some implementations, the fragment files are transferred over different routes to and from the Internet using, for example, two or more Internet Service Providers (ISPs). In some implementations, the restoring instructions can be retrieved by a user from a network (e.g., from a website) using a link sent with the email. In another implementation, the instructions are uploaded on a website or other web property, which the recipient can access through a password or other security procedures. In some implementations, the instructions can be included in a protected application attached to the email sent to the recipient.

### RELATED APPLICATIONS

This application claims the benefit of priority from U.S. Provisional Patent Application No. 60/781,112, for “A System for Protecting Attachments to Electronic Mail Messages (Emails) or Other Electronic File Transfer from Interception, Illegal Access or Copying or Being Obtained by any Person or Machine, Other than the Intended Recipient(s),” filed Mar. 10, 2006, which provisional patent application is incorporated by reference herein in its entirety.

This application is related to U.S. Provisional Patent Application No. 60/781,113, for “A System for Protecting Files Residing on a PC Hard Drive From Illegal Access or Copying by Anyone Other Than the Appropriate Owner/User of that PC,” filed Mar. 10, 2006, which provisional patent application is incorporated by reference herein in its entirety.

This application is related to U.S. patent application Ser. No. 10/844,565, for “Anti-Piracy Software Protection System and Method,” filed May 11, 2004, which patent application is incorporated by reference herein in its entirety.

### TECHNICAL FIELD

The disclosed implementations relate generally to electronic file security.

### BACKGROUND

Data and other information is regularly transmitted over networks (e.g., the Internet, intranet, Ethernet, wireless networks) using email or other electronic transfer protocol (e.g., File Transfer Protocol (FTP)). Since email systems are often attacked by hackers, many users are concerned about the security of their email text and attachments, which may contain sensitive information.

Emails are typically generated by a user connected to an originating Internet Service Provider (ISP), directly or indirectly (e.g., through an in-office server). The email is transmitted by the originating ISP as a number of packets. The packets are received by a receiving ISP, which assembles the packets into the original email and transfers the email to the intended recipient. It is generally accepted that it is difficult, if not impossible, to intercept and reconstruct an email message while the message traverses a packet switched network, such as the Internet.

In a packet switched network, however, the weak links are typically from the originator to the Internet and from the Internet to the recipient, since the email message and any attachments travel over these links as an integrated package and are not split into individual packets. The integrated package can be intercepted on these weak links and illegally accessed, compromising the user's sensitive information.

### SUMMARY

An electronic file is decomposed into a number of fragments. The fragments are assembled (e.g., randomly) into a number of fragment files. Instructions for restoring the electronic file are generated. The fragment files are sent to a recipient device at different times and/or in a random (or predefined) order. In some implementations, the fragment files are transferred over different routes to and from the Internet using, for example, two or more Internet Service Providers (ISPs). In some implementations, the restoring instructions can be retrieved by a user from a network (e.g., from a website) using a link sent with the email. In another implementation, the instructions are uploaded on a website or other web property, which the recipient can access through a password or other security measures or procedures. In some implementations, the instructions can be included in a protected application attached to the email sent to the recipient.

In some implementations, a method of protecting a transfer of an electronic file over a network includes: decomposing an electronic file into fragments; assembling the fragments into fragment files; generating instructions for restoring the electronic file from the fragments; and transferring the fragment files to an intended recipient at different times.

In some implementations, a method of restoring a protected electronic file received by an intended recipient device over a network includes: at the recipient device: receiving from the network, at different times, a number of fragment files; receiving instructions from the network; extracting fragments from the fragment files; and restoring the electronic file from the fragments using the instructions.

Other implementations are disclosed that are related to systems, methods and computer-readable mediums.

### DESCRIPTION OF DRAWINGS

FIG. 1 is a schematic diagram showing an example of a system for protecting a transfer of an electronic file over a network.

FIG. 2 is a block diagram showing an example of a system for protecting a transfer of an electronic file over a network.

FIG. 3 is a flow chart showing an example of a process for protecting a transfer of an electronic file over a network.

FIG. 4 is a flow chart showing an example of a process for restoring a protected electronic file received by an intended recipient device over a network.

FIG. 5 is a schematic diagram showing an example of a generic system for implementing the processes shown in FIGS. 3 and 4.

### DETAILED DESCRIPTION

### File Decomposition

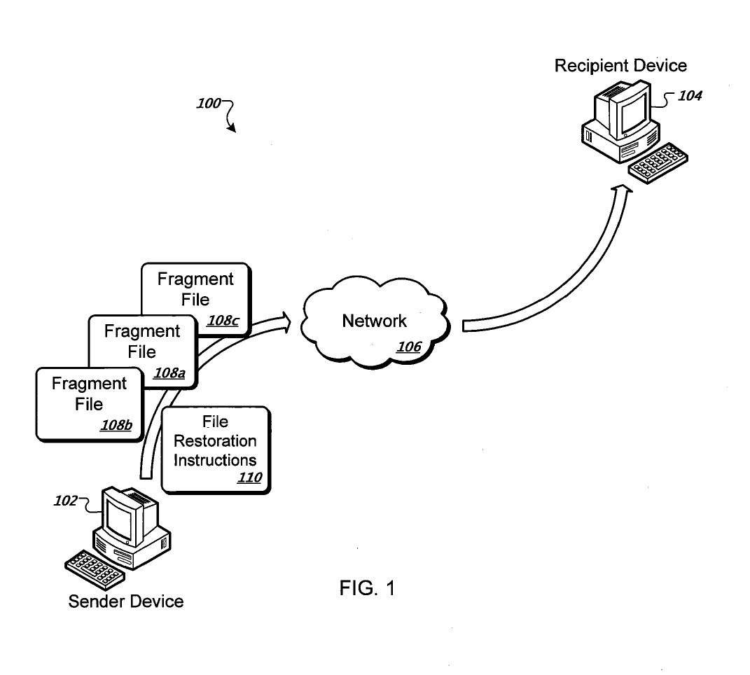

FIG. 1 is a schematic diagram showing an example of a system 100 for protecting a transfer of an electronic file over a network. The system 100 includes a sender device 102, a recipient device 104, and a network 106. The system 100 protects the transfer of an electronic file transferred to the recipient device 104 by decomposing the electronic file into a number of fragments. The system 100 assembles the fragments into a number of fragment files 108a-c and sends the fragment files 108a-c to the recipient device 104 over the network 106 (e.g., the Internet, intranet, Ethernet, wireless network) at different times. The electronic file may include but is not limited to: an email, an instant message, a web page, a document, a video file, an audio file, a digital photo, etc. The fragment files 108a-c may be transferred using a network protocol, such as Simple Mail Transfer Protocol (SMTP), Post Office Protocol version 3 (POP3), or File Transfer Protocol (FTP). In certain implementations, the system 100 randomly assembles the fragments of the electronic file into the fragment files 108a-c. In certain implementations, the system 100 sends the fragment files 108a-c to the recipient device 104 in a random or predefined order. The system 100 also generates file restoration instructions 110 for restoring the fragments into the electronic file and sends the file restoration instructions 110 to the recipient device 104.

For example, the fragment files 108a-c may include identifiers that distinguish each of the fragment files 108a-c from one another. The file restoration instructions 110 may reference the file fragment identifiers in describing how to restore the electronic file.

The system 100 sends the fragment files 108a-c and the file restoration instructions 110 to the recipient device 104. In certain implementations, the system 100 sends at least some of the fragment files 108a-c at different times (e.g., slightly different times).

The recipient device 104 receives the fragment files 108a-c from the network 106 at different times. The recipient device 104 can also receive the file restoration instructions 110 from the network 106. Alternatively, the recipient device 104 can receive the restoration instructions 110 through other means (e.g., delivered on a storage media, over phone lines). The recipient device 104 extracts fragments from the fragment files 108a-c. The recipient device 104 uses the file restoration instructions 110 to restore the fragments into the original electronic file.

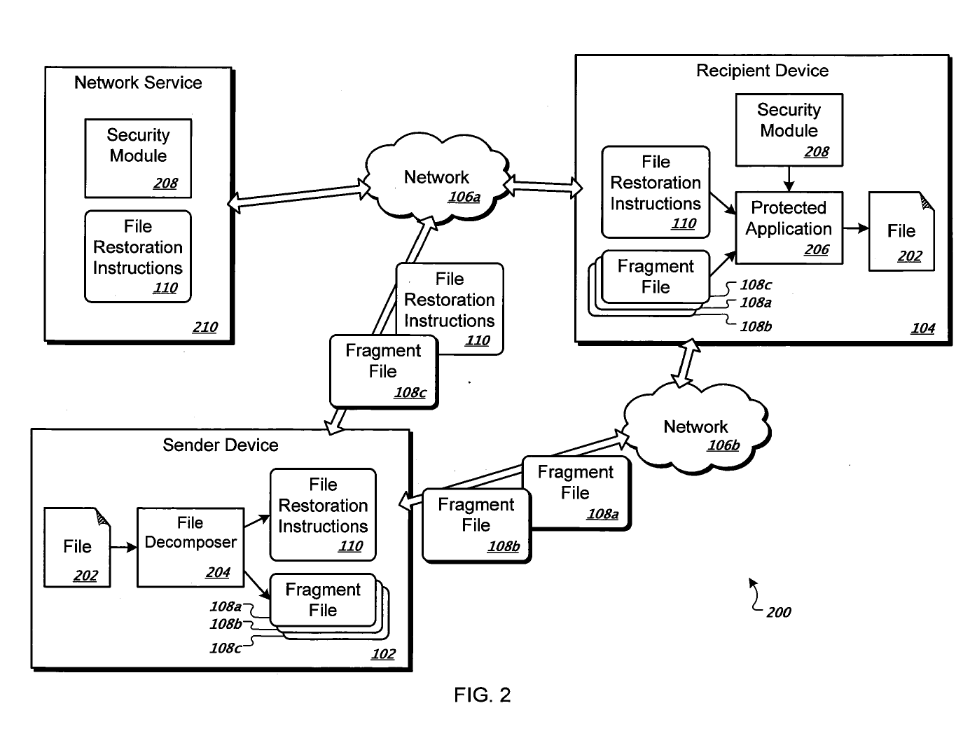

FIG. 2 is a block diagram showing an example of a system 200 for protecting a transfer of an electronic file over a network. The system 200 includes the sender device 102 which protects the transfer of an electronic file 202 to the recipient system 104 by fragmenting the electronic file 202. The sender device 102 includes a file decomposer 204. The file decomposer 204 decomposes the electronic file 202 into fragments and assembles the fragments into the fragment files 108a-c. The file decomposer 204 also generates the file restoration instructions 110 for restoring the fragments into the electronic file 202.

In certain implementations, the sender device 102 sends the fragment files 108a-c over different network routes 106a and 106b. The network routes 106a and 106b may be different network access service providers. In certain implementations, one or more of the networks 106, 106a, and 106b may be the Internet or other network. For example, the sender device 102 may send the file fragment 108c through the network 106a and then the fragment files 108a and 108b through the network 106b to the recipient device 104. The sender device 102 may send the file restoration instructions 110 through the network 106a.

In certain implementations, the recipient device 104 includes a protected application 206. The protected application 206 may be a stand alone application. Alternatively or in addition, the protected application 206 may be an add-on or plug-in to another application, such as an email viewer, a web browser, an instant message client, a media player, a document viewer, etc. The recipient device 104 receives the fragment files 108a-c over the different network routes 106a and 106b, and possibly through different network service access providers. The protected application 206 extracts fragments from the fragment files 108a-c. The protected application 206 uses the file restoration instructions 110 to restore the electronic file 204 from the fragments.

In certain implementations, the file decomposer 204 incorporates the file restoration instructions 110 into the protected application 206. The sender device 102 sends a portion of the protected application 206 to the recipient device 104 along with the fragment files 108a-c. The sender device 102 may change the protected application 206 before sending the protected application 206 to make the protected application 206 inoperable. The inoperable protected application 206 prevents unauthorized access to the electronic file 202.

For example, the file decomposer 204 may remove a portion of the program code of the protected application 206 and store the removed portion of the protected application 206 on the network 106a at a network service 210. Particularly, the removed portion may be a security module 208 that includes additional instructions to the protected application 206 for making the protected application 206 operable. The sender device 102 may provide a link to the recipient device 104 that establishes communication with the network service 210. For example, the link may be a hyperlink to a web page at the network service 210.

In certain implementations, the recipient device 104 makes a request for the security module 208, for example, in response to a user selecting the link to the network service 210. The network service 210 receives the request for the security module 208. The network service 210 may send a response requesting security information from the recipient device 104, such as a user name and password, a generated secure identifier, or biometric information. The recipient device 104 provides the security information, such as from an input made by a user. The network service 210 authenticates the recipient device 104 using the security information. For example, the network service 210 may compared the received security information to stored security information associated with the user or the recipient device 104. Upon successful authentication, the network service 210 sends the security module 208 to the recipient device 104.

In certain implementations, the recipient device 104 invokes the protected application 206. The protected application 206 dynamically links with the security module 208. Using the dynamic link, the security module 208 provides additional instructions to the protected application 206 for making the protected application 206 operable. For example, the security module 208 may be a dynamic link library (DLL) or a shared object library. The security module 208 may provide instructions, such as an encryption key used to decrypt the fragment files 108a-c or a pointer to a function in the program code of the protected application 206. The protected application 206 may execute the function at the location of function pointer to restore the fragments into the electronic file 202.

Alternatively, the sender device 102 may store the file restoration instructions 110, or one or more of the fragment files 108a-c, at the network service 210. The recipient device 104 may request the file restoration instructions 110 and/or one or more of the fragment files 108a-c from the network service 210. The network service 210 may authenticate the recipient device 104 as described above.

In certain implementations, the file restoration instructions are sent to the recipient device using techniques described in, for example, U.S. patent application Ser. No. 10/844,565, for “Anti-Piracy Software Protection System and Method.”

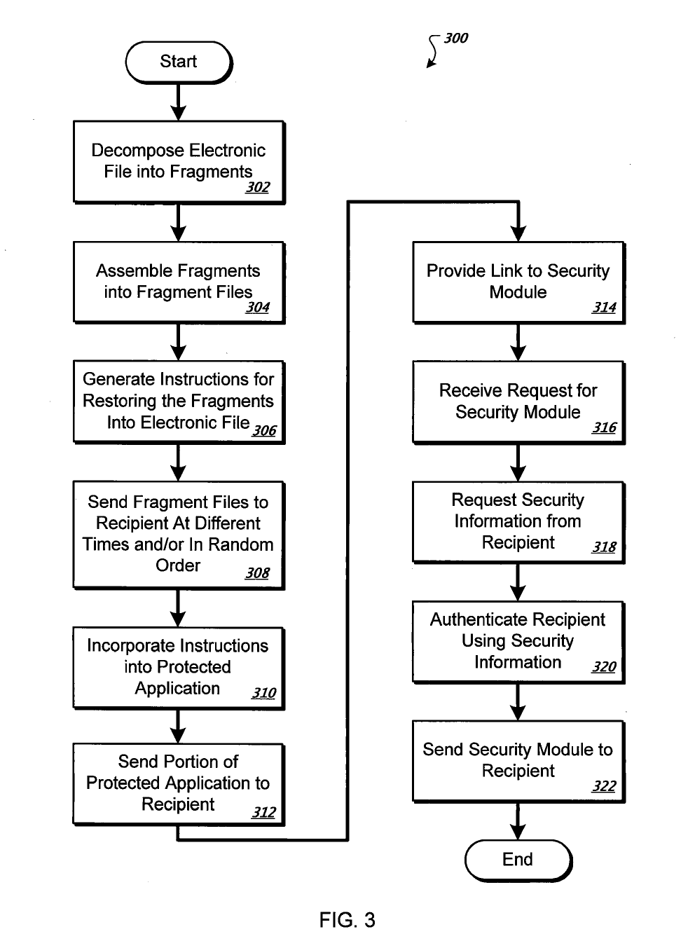

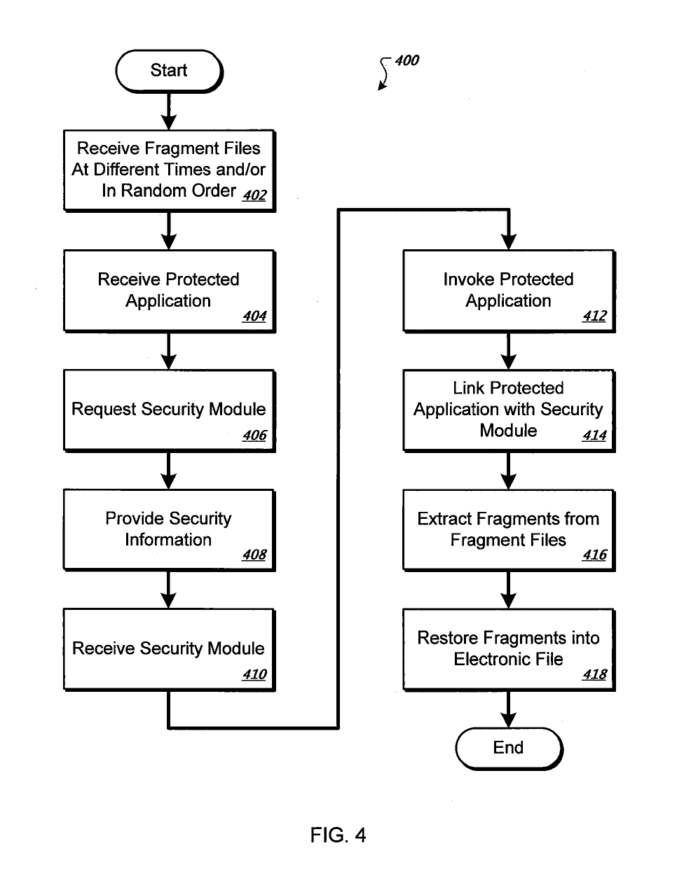

FIGS. 3 and 4 are flow charts showing examples of processes 300 and 400 for protecting and restoring an electronic file transferred over a network, respectively. The processes 300 and 400 may be performed, for example, by a system such as the system 200. For clarity of presentation, the description that follows uses the system 200 as the basis of an example for describing the processes 300 and 400. However, another system, or combination of systems, may be used to perform the processes 300 and 400.

FIG. 3 is a flow chart showing an example of the process 300 for protecting a transfer of an electronic file over a network. The process 300 begins with decomposing (302) an electronic file into a number of fragments. In certain implementations, the electronic file may be one or more of an email, an instant message, a web page, a document, a video file, an audio file, a digital photo, etc. For example, the file decomposer 204 decomposes the electronic file 202 into a number of fragments.

The process 300 assembles (304) the fragments into a number of fragment files. In certain implementations, the process 300 randomly assembles the fragments into fragment files. For example, the file decomposer 204 assembles the fragments into the fragment files 108a-c.

The process 300 generates (306) instructions for restoring the fragments into the electronic file. For example, the file decomposer 204 generates the file restoration instructions 110 (e.g., instructions for reassembling the fragments into the electronic file).

The process 300 sends (308) the fragment files to an intended recipient device. The process 300 sends at least some of the fragment files at different times. In certain implementations, the process 300 sends the fragment files to the recipient device over different network routes, such as through different network access service providers. In certain implementations, the process 300 sends the fragment files to the recipient device over the Internet or other network. In certain implementations, the process 300 sends the fragment files to the recipient device in a random order. For example, the sender device 102 sends the file fragment 108c to the recipient device 104 through the network 106a. The sender device 102 then sends the fragment files 108a and 108b to the recipient device 104 through the network 106b. As used herein, the term “random order” includes pseudo random order. In certain implementations, the fragment files can be sent in a predefined order and not necessarily random order.

In certain implementations, the process 300 incorporates (310) the file restoration instructions into a protected application. For example, the file decomposer 204 incorporates the file restoration instructions 110 into the protected application 206.

The process 300 sends (312) a portion of the protected application to the recipient device. In certain implementations, the process 300 changes program code of the protected application to make it inoperable, such as by removing a security module portion and storing the removed security module portion on the network. For example, the sender device 102 sends the inoperable protected application 206 to the recipient device 104 and the sender device 102 sends the security module 208 to the network service 210.

The process 300 provides (314) a link to the security module. For example, the sender device 102 may include a link to the network service 210 in a message sent to the recipient device 104.

The process 300 receives (316) a request for the security module. For example, the recipient device 104 may send a request for the security module 208 to the network service 210 in response to a user selecting the link to the network service 210.

The process 300 requests (318) security information from the recipient device. For example, the network service 210 may request a password or biometric information from the recipient device 104.

The process 300 authenticates (320) the recipient device using the security information. For example, the network service 210 authenticates the security information received from the recipient device 104, such as by comparing the received security information to stored security information associated with the recipient device 104.

The process 300 sends (322) the security module to the recipient device. For example, upon successfully authenticating the recipient device 104, the network service 210 sends the security module 208 to the recipient device 104.

FIG. 4 is a flow chart showing an example of the process 400 for restoring a protected electronic file received by an intended recipient device over a network. The process 400 begins with receiving (402) a number of fragment files at different times from a network. In certain implementations, the process 400 receives the fragment files over different network routes, such as through different network service access providers. For example, the recipient device 104 receives the file fragment 108c through the network 106a and the fragment files 108a and 108b through the network 106b.

The process 400 receives (404) a protected application that includes at least some instructions for restoring the fragment files into an electronic file. For example, the recipient device 104 receives the protected application 206 from the sender device 102.

In certain implementations, the process 400 requests (406) a security module containing additional instructions for restoring the fragment files into the electronic file from a network service. For example, the recipient device 104 may request the security module 208 from the network service 210. The request may be in response to a user selecting a link to the network service 210.

The process 400 provides (408) security information to the network service to gain access to the network service. For example, the recipient device 104 may receive an input from a user including a password or biometric information. The recipient device 104 provides the security information to the network service 210.

The process 400 receives (410) the security module from the network service. For example, the recipient device 104 receives the security module 208 from the network service 210.

The process 400 invokes (412) the protected application on the recipient device. For example, the recipient device 104 invokes the protected application 206.

The process 400 dynamically links (414) the protected application with the security module. The dynamic link makes the protected application operable to restore the fragments into the electronic file. For example, the protected application 206 dynamically links with the security module 208 to receive additional instructions for restoring the fragments into the electronic file 202.

The process 400 extracts (416) fragments from the fragment files. For example, the protected application 206 extracts fragments from the fragment files 108a-c.

The process 400 restores (418) the fragments into the electronic file using the file restoration instructions. For example, the protected application 206 restores the extracted fragments into the electronic file 202 using the file restoration instructions 110 embedded in the protected application and the security module 208.

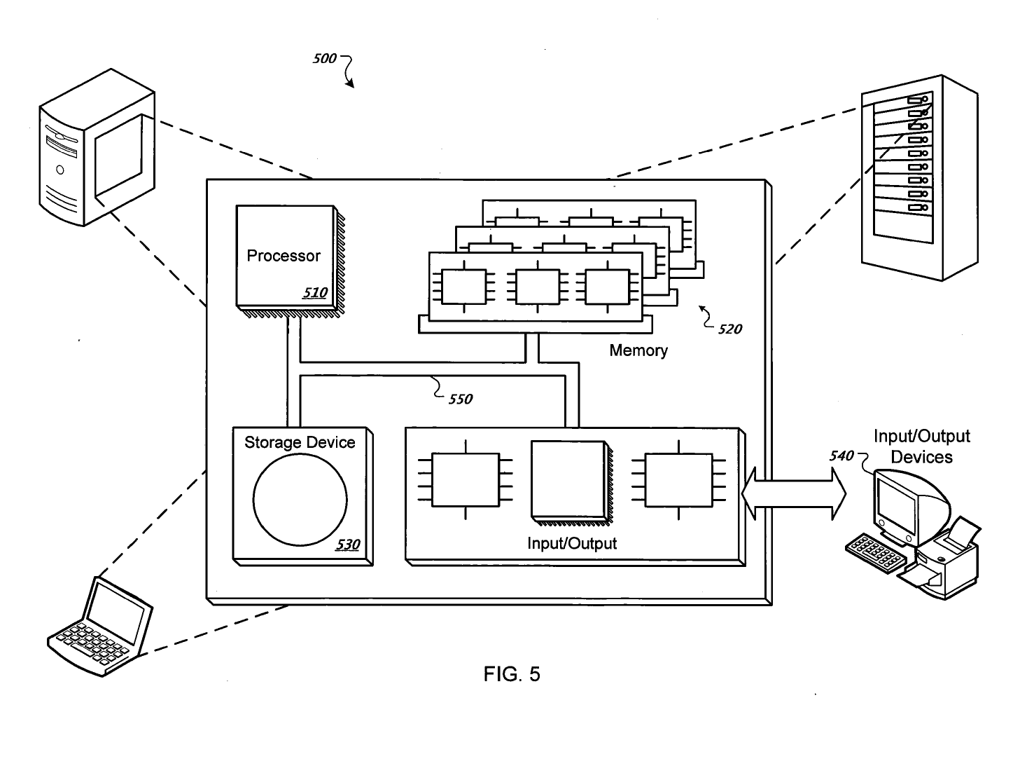

FIG. 5 is a schematic diagram showing an example of a generic system 500 for implementing the processes 300 and 400 shown in FIGS. 3 and 4, respectively. For example, the system 500 may be included in either or all of the sender device 102, the recipient device 104, and the network service 210.

The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. Multiple processors or a single processor with multiple processing cores can also be used. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method of protecting a transfer of an electronic file over a network, comprising:
decomposing an electronic file into fragments;
assembling the fragments into fragment files;
generating instructions for restoring the electronic file from the fragments; and
transferring the fragment files to an intended recipient at different times.

2. The method claim 1, further comprising:
randomly assembling the fragments into fragment files.

3. The method of claim 1, further comprising:
sending the fragment files to the intended recipient over different network routes.

4. The method of claim 3, wherein sending the fragment files to the intended recipient over different routes further comprises:
sending the fragment files to the intended recipient over different routes using different network access service providers.

5. The method of claim 3, wherein the network is a packet switched network.

6. The method of claim 1, wherein the electronic file is from a group of electronic files consisting of: emails, email attachments, instant messages, web pages, documents, video files, audio files, digital photos and any combination thereof.

7. The method of claim 1, wherein sending the fragment files further comprises:
sending the fragment files to the intended recipient in random order.

8. The method of claim 1, wherein sending the instructions further comprises:
incorporating the instructions into a protected application; and
sending at least a portion of the protected application to the intended recipient.

9. The method of claim 8, further comprising:
providing a link to the intended recipient for establishing communication with the network;
receiving a request for the instructions through the link; and
responsive to the request, providing the intended recipient with the instructions over the network.

10. The method of claim 9, further comprising:
requesting security information from the intended recipient;
authenticating the intended recipient using the security information, and
upon successful authentication, sending the instructions to the intended recipient device.

11. The method of claim 8, wherein providing the intended recipient with instructions further comprises:
sending a security module to the intended recipient, the security module capable of dynamically linking with the protected application for providing additional instructions to the protected application to make the protected application operable.

12. The method of claim 8 further comprising:
changing program code of the protected application to make the protected application inoperable.

13. The method of claim 12, wherein changing the protected application further comprises:
removing a portion of the program code of the protected application; and
storing the removed program code on the network.

14. The method of claim 1, wherein the instructions are made available to the recipient on the network.

15. A method of restoring a protected electronic file received by an intended recipient device over a network, comprising:
at the recipient device:
receiving from the network, at different times, a number of fragment files;
receiving instructions from the network;
extracting fragments from the fragment files; and
restoring the electronic file from the fragments using the instructions.

16. The method of claim 15, wherein receiving the fragment files further comprises:
receiving the fragment files over different network routes.

17. The method of claim 15, wherein receiving the fragment files further comprises:
receiving the fragment file from different network service access providers.

18. The method of claim 15, wherein receiving the fragment files further comprises:
receiving the fragment files in random order.

19. The method of claim 15, wherein receiving the instructions from the network further comprises:
receiving a protected application including at least some of the instructions;
requesting a security module containing additional instructions from a network service;
providing security information to the network service to gain access to the network service;
upon gaining access, receiving a security module from the network service;
invoking the protected application on the recipient device; and
dynamically linking the protected application with the security module to make the protected application operable to restore the fragments into the electronic file using the protected application.

20. The method of claim 15, wherein receiving the instructions from the network further comprises:
receiving the instructions with the fragment files.

21. A system for protecting a transfer of an electronic file over a network, comprising:
a processor;
a computer-readable medium coupled to the processor and including instructions, which, when executed by the processor, causes the processor to perform operations comprising:
decomposing an electronic file into fragments;
assembling the fragments into fragment files;
generating instructions for restoring the electronic file from the fragments; and
transferring the fragment files to an intended recipient at different times.

22. The system claim 21, wherein the fragments are randomly assembled into fragment files.

23. The system of claim 21, wherein the fragment files are sent to the intended recipient over different network routes.

24. The system of claim 23, wherein the fragment files are sent to the intended recipient over different routes using different network access service providers.

25. The system of claim 21, wherein the network is a packet switched network.

26. The system of claim 21, wherein the electronic file is from a group of electronic files consisting of: emails, email attachments, instant messages, web pages, documents, video files, audio files, digital photos and any combination thereof.

27. The system of claim 21, wherein the fragment files are sent to the intended recipient in random order.

28. The system of claim 21, wherein the instructions are incorporated into a protected application, and at least a portion of the protected application is sent to the intended recipient.

29. The system of claim 21, wherein the instructions are made available to the recipient through a link provided to the recipient over the network.

30. A computer-readable medium having instructions stored thereon, which, when executed by a processor, causes the processor to perform operations comprising:
decomposing an electronic file into fragments;
assembling the fragments into fragment files;
generating instructions for restoring the electronic file from the fragments; and
transferring the fragment files to an intended recipient at different times.

31. A computer-readable medium having instructions stored thereon, which, when executed by a processor, causes the processor to perform operations comprising:
at a recipient device:
receiving from a network, at different times, a number of fragment files;
receiving instructions from the network;
extracting fragments from the fragment files; and
restoring the electronic file from the fragments using the instructions.

32. A system for protecting a transfer of an electronic file over a network, comprising:
means for decomposing an electronic file into fragments;
means for assembling the fragments into fragment files;
means for generating instructions for restoring the electronic file from the fragments; and
means for transferring the fragment files to an intended recipient at different times.
